(19) United States
(12) Patent Application Publication
(10) Pub. No.: US 2010/0117972 A1
(43) Pub. Date: May 13, 2010

(54) ELECTRONIC DEVICE WITH INFRARED TOUCH INPUT FUNCTION

(75) Inventors: XIN ZHAO, Shenzhen City (CN); ZU-PEI HE, Shenzhen City (CN); RUEY-SHYANG YOU, Tu-Cheng (TW); HUA-DONG CHENG, Shenzhen City (CN); HAN-CHE WANG, Tu-Cheng (TW); KUAN-HONG HSIEH, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/545,875

(22) Filed: Aug. 24, 2009

(30) Foreign Application Priority Data
Nov. 7, 2008 (CN) 200810305420.5

(51) Int. Cl. G06F 3/041

(52) U.S. Cl. 345/173

(57) ABSTRACT

An electronic device with infrared touch input function is provided. The electronic device includes a display unit defining an information display area; an infrared input device including a circuit board having two pairs of oppositely disposed sides defining an open area corresponding in size and shape to the information display area, at least one light emitting device; a linear array of light detecting devices faced to light emitting devices, connected together via first resistances respectively to form a node; an analog/digital (A/D) converter configured to convert a voltage across the node into digital values; a micro-processing unit for determining an infrared light path being obstructed; and the CPU configured for controlling the display unit displaying a plurality of menu options, determining the menu option being touched; and performing functions corresponding to the menu option.

### RELATED APPLICATIONS

This application is related to copending applications entitled, “ELECTRONIC DEVICE WITH INFRARED TOUCH INPUT FUNCTION”, filed ______ (Atty. Docket No. US 23304); “ELECTRONIC DEVICE WITH INFRARED TOUCH INPUT FUNCTION”, filed ______ (Atty. Docket No. US23305); and “ELECTRONIC DEVICE WITH INFRARED TOUCH INPUT FUNCTION”, filed ______ (Atty. Docket No. US24653).

### BACKGROUND

1. Technical Field

The disclosure relates to electronic devices with an input function and, particularly, to an electronic device with infrared touch input function.

2. General Background

It is well known that an infrared input system comprises a circuit board having a first pair of opposed sides positioned parallel to a first axis and a second pair of opposed sides positioned parallel to a second axis, the second axis being perpendicular to the first axis, each of the second pair of sides connecting the first pair of sides, all four sides defining a generally rectangular touch input area, a linear array of light emitting devices along each side, and a light detection device positioned at each corner of the circuit board; and a controller coupled to the light emitting devices and the light detection devices, wherein the controller sequentially activates each linear array and activates the light detection devices positioned at corners of the circuit board opposed to the activated array of light emitting devices. The system can discern the location of a touch within the information display area by implementing an algorithm on x, y coordinates detected by the detectors, which is complicated and time consuming.

Therefore, it is necessary to provide a electronic device with infrared touch input function to implement the functions in a simpler way.

### BRIEF DESCRIPTION OF THE DRAWINGS

FIG. 1 is an exploded, schematic view showing an electronic device with an infrared touch input function in accordance with a first exemplary embodiment.

FIG. 2 is a schematic diagram showing the electronic device of FIG. 1.

FIG. 3 is a block diagram showing an internal configuration of the electronic device of FIG. 1.

FIG. 4 is a flowchart implemented by the electronic device of FIG. 2.

### DETAILED DESCRIPTION

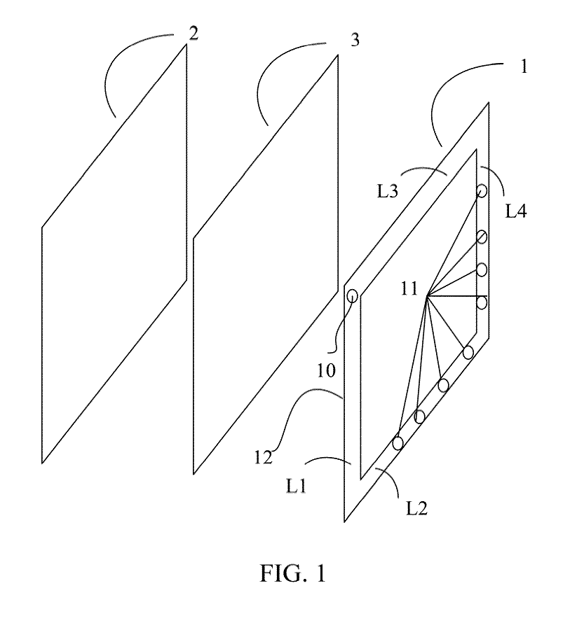

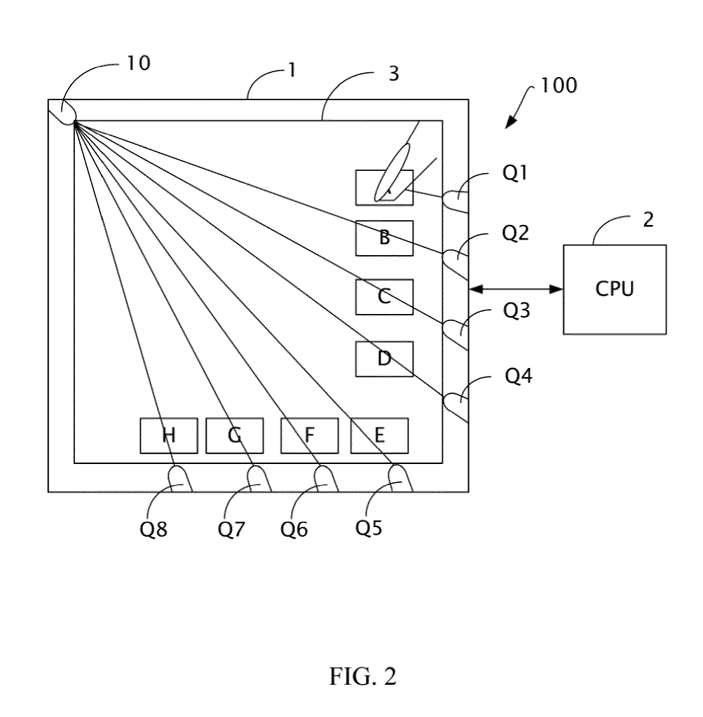

Referring to FIGS. 1-2, the electronic device 100 includes an infrared input device 1, a central processing unit (CPU) 2, and a display unit 3. The CPU 2 is electronically connected to the infrared input device 1 and the display unit 3. The display unit 3 may be a flat panel display disposed sides defining an information display area.

The infrared input device 1 may include a circuit board 12 having two pairs of oppositely disposed sides (L1, L2, L3, and L4) defining an open area corresponding in size and shape to the information display area. The circuit board 12 includes at least one light emitting device 10 and a linear array of light detecting devices 11 (Q1-Q8). In an exemplary embodiment, the light emitting devices 10 are organic light emitting diodes that emit light in the infrared (IR) range (D1), and the light detecting devices 11 are light phototransistors (Q1-Q8). The light detecting devices 11 can be positioned on one side or two adjacent sides of the circuit board 12. The light emitting device 10 is positioned at one corner of the circuit board 12 and faces the light detecting devices 11. The light detecting devices 11 are used for detecting infrared light emitted by the light emitting device 10. For example, in the exemplary embodiment, the light emitting device 10 is positioned at the top right corner of the circuit board 12.

The CPU 2 is configured to control the display unit 3 to display a plurality of menu options corresponding to the light detecting devices 11. The number of the menu options displayed will be the same as the number of the light detecting devices 11. As shown in FIG. 2, there are 8 menu options A-H respectively corresponding to the light detecting devices Q1-Q8. When one menu option is touched by a user, an infrared light path between the light emitting device 10 and the corresponding light detecting device 11 is obstructed, as a result, the corresponding light detecting device 11 does not detect the infrared light emitted by the corresponding light emitting device 10. The CPU 2 is configured to determine the menu option touched by the user when the corresponding light detecting device 11 detects an interruption of the infrared light emitted by the corresponding light emitting device 10 and thereby performs a function corresponding to the menu option.

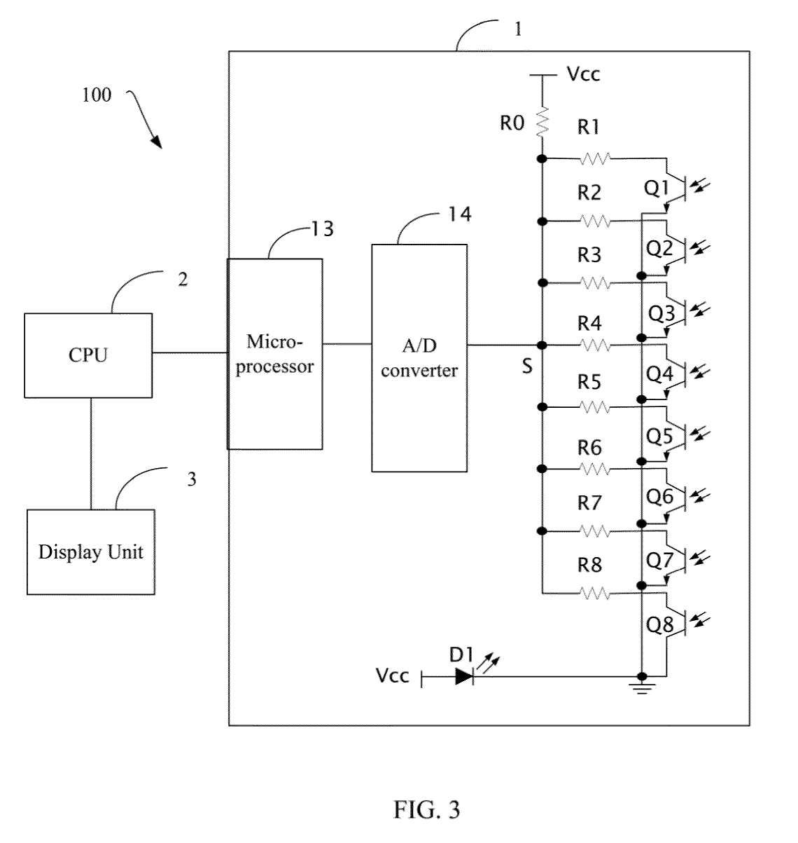

FIG. 3 is a block diagram showing the internal configuration of the electronic device 1. The infrared input device 1 further includes a micro-controller 13 connected to the CPU 2 and an analog/digital (A/D) converter 14 connected to the micro-controller 13. The collectors of Q1-Q8 are commonly connected together respectively via resistances R1-R8 to form a node S. The node S is further connected with the A/D converter, and a voltage source Vcc via a resistance R0. The emitters of Q1-Q8 are connected to ground. The anode of the light emitting device 10 is further connected to the voltage source Vcc, and the cathode of the light emitting devices 10 is connected to ground.

When none of the menu options is being touched, the infrared light paths between the light emitting device 10 and the light detecting devices 11 are unobstructed, and all the light detecting devices 11 detect the infrared light, thereby the node S is grounded via R1-R8. Voltage across the node S equals Vcc*(R1* . . . R7*R8)/(R0*(R1+ . . . R7+R8)+R1* . . . R7*R8). When one menu option is touched, take menu option A for example, the infrared light path between Q1 and D1 is obstructed, thereby R1 is not connected to ground. The voltage across the node S is then equal to Vcc*(R2* . . . R7*R8)/(R0*(R2+ . . . R7+R8)+R2* . . . R7*R8). The A/D converter 14 converts the voltage across the node S into digital values and sends the digital values to the micro-processor 13. R0-R8 may be set to different values to make the digital values different for different conditions of different menu option being touched. The micro-controller 13 is further configured to determine which infrared light path is obstructed according to the digital value.

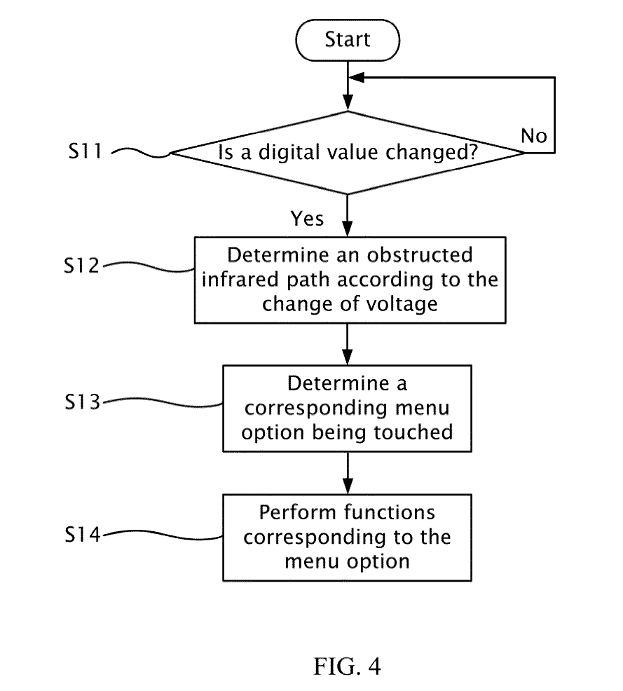

FIG. 4 is a flowchart implemented by the electronic device 100.

In step S11, the micro-controller 13 detects whether the digital values are changed. If yes, the procedure goes to step S12, if no, the micro-controller 13 continues to detect. In step S12, the micro-processor 13 determines the infrared light path being obstructed according to the digital value sent to the CPU 2. For example, the micro-processor 13 looks up a table that records relationship of the digital values and corresponding infrared light paths, and determines the infrared light path according to the table. In step S13, the CPU 2 determines which menu option is touched corresponding to the infrared light path being obstructed, and sends a control signal to the CPU 2. In step S14, the CPU 2 performs functions corresponding to the menu option being touched according to the control signal.

In order to avoid misoperation, only when the time of the changed digital values remaining same lasts for a predetermined time, the micro-processor 13 sends the control signal to the CPU 2 to perform the functions corresponding to the menu option.

Although the present disclosure has been specifically described on the basis of an exemplary embodiment thereof, the disclosure is not to be construed as being limited thereto. Various changes or modifications may be made to the embodiments without departing from the scope and spirit of the disclosure.

What is claimed is:

1. An electronic device with infrared touch input function, comprising:
a display unit defining an information display area;
an infrared input device comprising a circuit board having two pairs of oppositely disposed sides defining an open area corresponding in size and shape to the information display area,
at least one light emitting device positioned on one corner of the circuit board, configured for emitting infrared light;
a linear array of light detecting devices positioned on one side or two adjacent sides of the circuit board and faced to light emitting devices, configured for detecting infrared light emitted by the light emitting devices, wherein, the light detecting devices are connected together via first resistances respectively to form a node that is connected to a voltage source via a second resistance, the first resistances and the second resistance have different resistance values from each other;
an analog/digital (A/D) converter configured to connect with the node and convert a voltage across the node into digital values; and
a micro-processing unit configured for determining an infrared light path being obstructed according to the digital values, and generating a control signal to a central processing unit(CPU); and
the CPU electronically connected with the infrared input device and the display unit, configured for controlling the display unit displaying a plurality of menu options corresponding to light detecting devices, determining the menu option being touched according to the control signal; and performing functions corresponding to the menu option.

2. The electronic device as claimed in claim 1, wherein the display unit is a flat panel display.

3. The electronic device as claimed in claim 1, wherein each light detecting device is an infrared phototransistor.

4. The electronic device as claimed in claim 1, wherein the at least one light emitting device is an organic light emitting diode.

5. The electronic device as claimed in claim 1, wherein the micro-processor sends a control signal to the CPU to perform the functions corresponding to the menu option when the digital values change and a time duration of the changed digital values remaining same lasts for a predetermined time.

6. The electronic device as claimed in claim 1, wherein the micro-processor is further configured to look up a table that records relationship of the digital values and corresponding infrared light paths to determine the infrared light path.

7. A method of controlling an electronic device with infrared touch input function, the electronic device comprising:
a display unit defining an information display area;
an infrared input device comprising a circuit board having two pairs of oppositely disposed sides defining an open area corresponding in size and shape to the information display area,
at least one light emitting device positioned on one corner of the circuit board, configured for emitting infrared light;
a linear array of light detecting devices positioned on one side or two adjacent sides of the circuit board and faced to light emitting devices, configured for detecting infrared light emitted by the light emitting devices, wherein, the light detecting devices are connected together via first resistances respectively to form a node that is connected to a voltage source via a second resistance, the first resistances and the second resistance have different resistance values from each other;
an analog/digital (A/D) converter configured to connect with the node and convert a voltage across the node into digital values; and
a micro-processing unit configured for determining an infrared light path being obstructed according to the digital values, and generating a control signal to a central processing unit(CPU);
the method comprising:
controlling the display unit displaying a plurality of menu options corresponding to light detecting devices,
determining the menu option being touched according to the control signal; and
performing functions corresponding to the menu option when the menu option is touched.

8. The method of controlling an electronic device according to claim 7, comprising: the micro-processor sending a control signal to the CPU to perform the functions corresponding to the menu option when the digital values change and a time duration of the changed digital values remaining same lasts for a predetermined time

9. The method of controlling an electronic device according to claim 7, comprising: the micro-processor looking up a table that records relationship of the digital values and corresponding infrared light paths to determine the infrared light path.

10. A method of controlling an electronic device with infrared touch input function, comprising:
determining an infrared light path being obstructed if digital values converted by a voltage across a node are changed;
determining which menu option is touched corresponding to the infrared light path being obstructed and sending a control signal;
performing functions corresponding to the menu option being touched according to the control signal.

11. The method of controlling an electronic device according to claim 10, comprising: detecting if the digital values are changed, and on condition of the digital values are unchanged, continuing to detect.

12. The method of controlling an electronic device according to claim 10, comprising the micro-processor sending a control signal to the CPU to perform the functions corresponding to the menu option when the digital values change and a time duration of the changed digital values remaining same lasts for a predetermined time.

13. The method of controlling an electronic device according to claim 10, comprising look up a table that records relationship of the digital values and corresponding infrared light paths to determine the infrared light path.
